(19) United States
(12) Patent Application Publication
(10) Pub. No.: US 2022/0340801 A1
(43) Pub. Date: Oct. 27, 2022

(54) A THERMAL CONDUCTIVE COMPOUND FOR SEALING A POWER TRANSFORMER ASSEMBLY AND A POWER TRANSFORMER ASSEMBLY

(71) Applicant: PREMO, SA, Campanillas (MALAGA) (ES)

(72) Inventor: Francisco Ezequiel NAVARRO PEREZ, Barcelona (ES)

(21) Appl. No.: 17/641,657

(22) PCT Filed: Aug. 20, 2020
(86) PCT No.: PCT/EP2020/073290

§ 371 Date: Mar. 9, 2022

(30) Foreign Application Priority Data
Sep. 18, 2019 (EP) 19382808.4

(51) Int. Cl. C09K 5/14; C08K 3/36; C08K 3/26; C08K 3/22; C08K 3/04; C08K 3/08; H01F 27/22; H01F 27/02; H01F 27/24; H01F 27/28

(52) U.S. Cl. CPC C09K 5/14; C08K 3/36; C08K 3/26; C08K 3/22; C08K 3/04; C08K 3/08; H01F 27/22; H01F 27/025; H01F 27/022; H01F 27/24; H01F 27/28; C08K 2201/001; C08K 2003/265; C08K 2003/2227

(57) ABSTRACT

A thermal conductive compound for sealing a power transformer assembly and a power transformer assembly, the thermal conductive compound having a silicone resin and fillers. The fillers at least include a first filler, or main filler, and a second filler. The first filler is a natural mineral filler including finely divided quartz, quartzite, marble, sand and/or calcium carbonate. The second filler includes a given amount of aluminium hydroxide lowering linear expansion coefficient and increasing the thermal conductivity of the silicone resin.

### TECHNICAL FIELD

The present invention relates to a thermal conductive compound for sealing and encapsulating a power transformer assembly. The invention also relates to a power transformer assembly that comprises said thermal conductive compound.

The thermal conductive compound, which comprises a flexible silicone-based resin and a plurality of fillers, has been specifically developed for its use in power transformers and power magnetic components, which may be exposed to high thermal demands due to their working cycles and with a thermal conductivity of 1.4 W/mK to 2.6 W/mK.

### BACKGROUND OF THE INVENTION

Japanese patent JP 4172113 B2 discloses a flame-retardant resin composition capable of providing an injection-moulded product, which is imparted with flame retardant properties by use of a halogen-free flame retardant and, at the same time, is excellent in moisture and head resistances and residence stability. The resin composition is excellent in heat and humidity resistance characteristics, retention stability, and is used for wire coating materials and moulded articles, for example, electrical and electronic parts such as connectors, relays, switches, case members, transformer members, coil bobbins, etc.

Japanese patent JP 3807139 B2 discloses an electric and electronic component such as an ignition coil which has a long life and a high durability suitable for a higher packaging density and a higher integration. The electronic component is sealed with an epoxy resin or silicone resin. Moreover, in order to lower the linear expansion coefficient and increase the thermal conductivity, generally, inorganic fillers such as silica and aluminium hydroxide can be added.

Japanese patent application JP 2003163131 A discloses a method of manufacturing a resin mould coil in which resin is coated around a coil.

U.S. Pat. Nos. 5,021,494, 7,566,500 B1, 6,025,435 A, US20080111111A1 and US2015376488 A1 disclose different thermal conductive silicon compositions useful for applications such as thermal interface materials in electronics packaging and for use as thermally conductive compound materials for transformers, power supplies, coils and other electronic devices that require improved thermal dissipation.

US2003050419A reveals a high thermal conductivity spin castable compound used to encapsulate circuitry, comprising a thermally conductive silicone gel.

U.S. Pat. No. 9,074,108 discloses a potting compound suitable for potting an electronic component; in particular a large-volume coil such as a gradient coil, consisting of a supporting matrix in which at least one first filler made of polymer nanoparticles is distributed. The supporting matrix also includes at least one secondary filler that is used as a flame retardant and at least one third filler comprising inorganic particles. The inorganic particles can consist of silicon dioxide (SiO2), aluminum oxide (Al2O3), aluminum nitride (AlN), calcium magnesium dicarbonate (CaMg(CO3)2), titanium dioxide (TiO2), synthetic ceramics, zeolites, chalk, talc (Mg3Si4O10(OH)2), wollastonite (CaSiO3) and/or purely carbon-based particles.

In spite of the cited known solutions, new embodiments of a sealed transformer assembly with increased heat dissipation and that preserves the integrity of the components are still desirable. New thermal conductive compounds for sealing and encapsulating such power transformer assembly, or other electronic components, are also needed.

### DESCRIPTION OF THE INVENTION

To that end, present invention provides according to a first aspect a thermal conductive compound for sealing a power transformer assembly. The thermal conductive compound, as known in the field, is comprised of fillers at least including a first filler (or main filler) and a second filler. The second filler includes a given amount of aluminium hydroxide.

Unlike the known proposals, the first filler is a natural mineral filler such as finely divided quartz, quartzite, marble, sand, calcium carbonate and/or combinations thereof. Furthermore, the thermal conductive compound additionally comprises a silicone resin.

The aluminium hydroxide particularly lowers the linear expansion coefficient of the silicone resin and also increases the thermal conductivity of the silicone resin.

In some embodiments, the thermal conductive compound can further include a third filler comprising a given limited amount of electroconductive particles which ensures an electrical isolation of the thermal conductive compound under an electrical voltage above 10 KV.

According to a second aspect there is also provided a power transformer assembly comprising, as known in the field, a (at least one) magnetic core with (at least) first and second wound coils, these elements being sealed by a thermal conductive compound with mechanical potting capability comprised of fillers.

The fillers can include a first filler (or main filler) and a second filler. The second filler particularly includes a given amount of aluminium hydroxide.

Unlike the above known proposals, in the present invention the thermal conductive compound also includes a silicone resin, and the first filler comprises a natural mineral filler, for example made of finely divided particles of quartz, quartzite, marble, sand, calcium carbonate and/or combinations thereof.

It is planned to use in a same thermal conductive compound different natural mineral fillers with diverse granulometries, combined finely divided and compacted.

In an embodiment, the proportion in the thermal conductive compound of the first filler is between 60 and 90%. The given amount of the aluminium hydroxide can be comprised in the range of 1-5% by weight with regard to the total weight of the thermal conductive compound including the silicone resin.

In an embodiment, the thermal conductive compound also includes a third filler comprising a given amount of thermal and electrically conductive particles such as metallic particles, metal oxides, graphite, etc., that provide an electrical resistance to the thermal conductive compound but the quantity of said particles being limited to an amount that guarantees an electrical isolation of the thermal conductive compound under an electrical voltage lower than 10 KV. The presence of thermal conductive and/or electroconductive particles in the third filler determines a significant increase in the thermal conductivity of the thermal conductive compound and therefore a rise in the heat evacuation capacity thereof.

The proposed power transformer can comprise several parts or magnetic units each of them including a magnetic core and windings, the several parts or magnetic units being arranged with a central part thereof positioned at a same level such that an isothermal gradient of temperature under working operation of the power transformer including the cited magnetic parts or magnetic units is achieved.

Moreover, the magnetic core(s) and wound coils according to a particular embodiment are arranged inside a housing (such a metallic box with a cover) delimited by metallic thermo-conductive walls. The metallic box can be made of different materials, for example aluminium, aluminium alloy or magnesium alloy with a thermal conductivity above 70 W/mK.

In an embodiment, the metallic box is provided with openings on a box base wall and in correspondence with the windings and of a size adjusted to them, said openings allowing an optimal heat transfer therethrough towards a dissipation device in adjacent position, such as a liquid cooling dissipation plate.

### BRIEF DESCRIPTION OF THE DRAWINGS

The previous and other advantages and features will be more fully understood from the following detailed description of embodiments, with reference to the attached figures, which must be considered in an illustrative and non-limiting manner, in which:

FIG. 1 shows an example of the proposed power transformer assembly including several magnetic units in an exploded perspective view.

FIG. 2 shows a cross-sectional view of one of the magnetic units of the power transformer assembly of FIG. 1.

FIG. 3 shows another exploded perspective view of the metallic box for loading the magnetic units of the power transformer assembly.

### DETAILED DESCRIPTION OF PARTICULAR EMBODIMENTS

Present invention proposes a power transformer assembly 1 and a thermal conductive compound 10 for sealing a power transformer assembly 1. The thermal conductive compound 10 provides thermal transfer capability and mechanical encapsulation to the power transformer assembly 1.

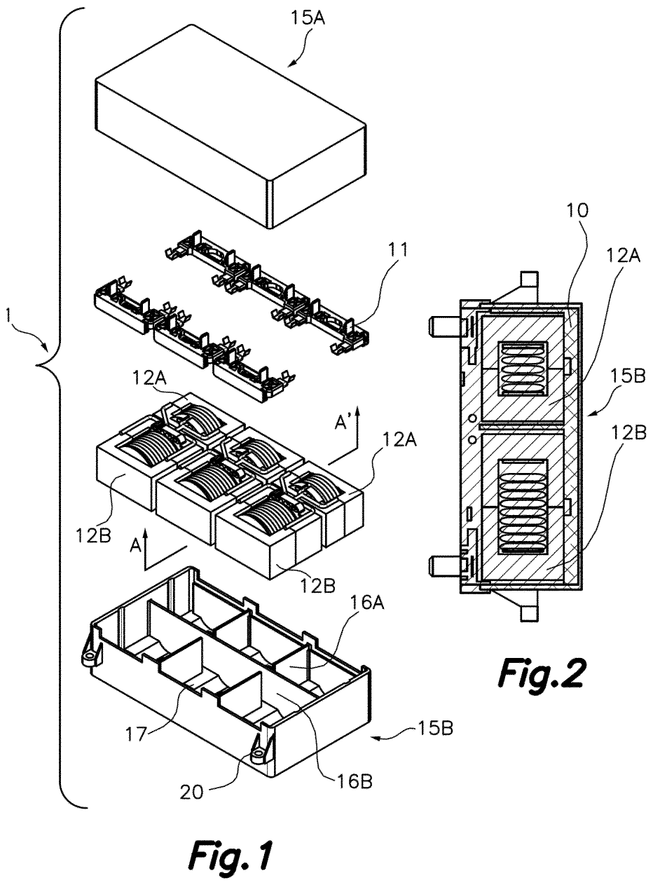

Referring to FIGS. 1 and 2, a power transformer assembly 1 according to a first exemplary embodiment of the present invention includes several magnetic cores 12A, 12B each including a first coil and a second coil wound around them (it should be noted that the power transformer assembly could comprise a single magnetic core 12A, 12B and more coils). The power transformer assembly 1 is sealed by a thermal conductive compound 10 made of a silicone resin and first and second fillers.

The thermal conductive compound is injected into the power transformer assembly 1 by controlled overpressure, and the air is removed and replaced by the thermal conductive compound which is then cured. This increases all thermal interfaces of the power transformer assembly 1 between materials from practically 0 W/mk (air) to a minimum of 1.4 W/mk and significantly increases the thermal dissipation capacities of the transformer assembly 1.

The first filler is made of a natural mineral filler such as finely divided quartz, quartzite, marble, sand, calcium carbonate and/or combinations thereof. Hence, the manufacturing costs of the power transformer assembly 1 are considerably reduced while the thermal dissipation capabilities of the transformer are improved.

The second filler is made of a given amount of aluminium hydroxide or its derivatives, thus lowering the linear expansion coefficient and increasing the thermal conductivity of the silicone resin. Moreover, this compound provides thermal protection against the Curie point of the magnetic core(s) 12A, 12B when subjected to heavy power by adding metal hydroxides that absorb heat by phase change enthalpy and transforming solid to gas (sublimation phase) keeping the temperature stable and below the Curie temperature throughout the process of releasing OH groups transformed into water.

The proportion of the first filler in the thermal conductive compound 10 can vary between 60 and 90%. Different thermal conductivity results can be achieved depending on the remaining part of the thermal conductive compound 10 (i.e. silicone resin and second fillers). For example, with 40% silicone and 60% aluminium hydroxide 1, 05 W/mk are achieved. With 35% silicone and 65% aluminium hydroxide 1, 2 W/mk are achieved.

In some embodiments, the thermal conductive compound 10 can further include a third filler comprising a limited amount of electroconductive particles. Hence, an electrical resistance is provided to the thermal conductive compound which guarantees its electrical isolation under an electrical voltage above 10 KV.

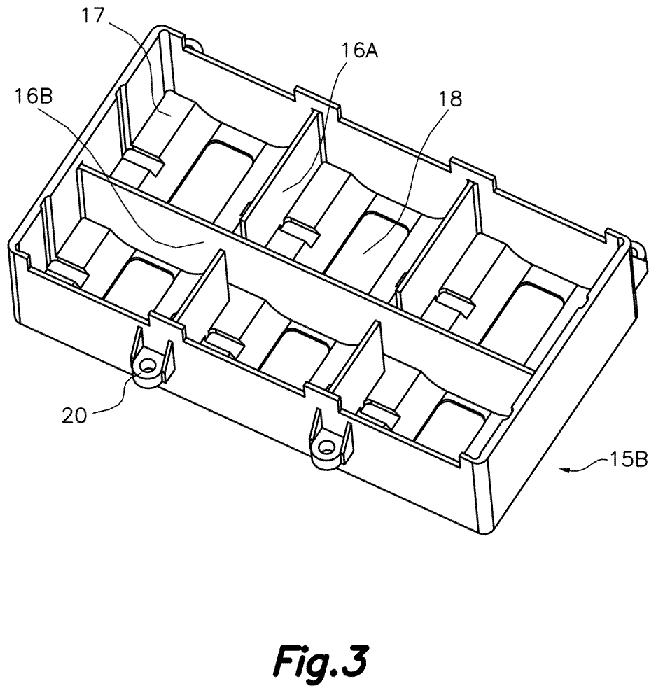

Referring back to FIGS. 1 and 2, the proposed power transformer assembly 1, in this example including several magnetic units arranged/placed inside several cavities of a metallic box 15B (see also FIG. 3 for an enlarged view of the metallic box 15B). The metallic box 15B, which can be made of any of aluminium, an aluminium alloy or a magnesium alloy, comprises metallic thermo-conductive walls 16A, 16B for enclosing/delimiting each magnetic core 12A, 12B and corresponding first and second coils and a cover 15A. The material of the metallic box 15B particularly has a thermal conductivity above 70 W/mK. As can be seen in FIG. 1, the assembly particularly also includes a stopper 11, which in this embodiment is an encapsulated electrical terminal that allows the connection of the primary/secondary windings of the magnetic unit within limits of the creepage/clearance electrical isolation. This is important in avoiding dependence on the electrical insulation of the thermal conductive compound 10 that fills the gaps in areas with a short creepage/clearance distance. In addition, the stopper 11 also contributes to securely hold the magnetic cores 12A, 12B inside each of the cavities of the metallic box 15B.

The metallic box 15B is custom designed with a base including one or more openings 18 adjusted to the tolerance of the winding area. This opening 18 allows that when the magnetic core 12A, 12B is installed attached to a liquid cooling dissipation plate, for example an Al plate, the distance from the winding to the cooling aluminium is minimal, allowing an optimal heat transfer due to a reduction of the heat transfer circuit to its minimum expression of thicknesses and materials. Thus, the losses generated in the copper (windings) are eliminated in a shorter space of time and in the most efficient way possible. Likewise, the metallic box is designed with a specifically adjusted inner raised support 17 to accommodate a homogeneous surface of the magnetic cores 12A, 12B. This inner support 17 is in direct contact with the magnetic core(s) 12A, 12B. This allows maximum heat dissipation generated by power losses in the core(s) 12A, 12B. The heat is transferred directly from the magnetic material to the metallic box 15B, and the latter then to the liquid cooling plate. The metallic box 15B includes also mounting holes 20 to attach the metallic box 15B to an installation point.

Particularly, the magnetic cores 12A, 12B are arranged in the different cavities of the metallic box 15B with a central part thereof at a same level, i.e. in a horizontal position, such that an isothermal gradient of temperature under working operation of the power transformer assembly 1 is achieved.

The invention as stated above also refers to a specific thermal conductive compound 10 for sealing a power transformer assembly with thermal transfer capability and mechanical encapsulation capacity. This thermal conductive compound 10 has been specifically developed for its application in magnetic power units, providing a thermal conductivity of 1.4 W/mK to 2.6 W/mK.

The thermal conductive compound 10 is comprised of a silicone resin and fillers at least including a first filler (or main filler) and a second filler. The second filler includes a given amount of aluminium hydroxide lowering the linear expansion coefficient and increasing the thermal conductivity of the silicone resin. The first filler is a natural mineral filler such as finely divided quartz, quartzite, marble, sand, calcium carbonate and/or combinations thereof.

In an embodiment, the thermal conductive compound 10 further includes a third filler comprising electroconductive particles but in a limited amount ensuring an electrical isolation of the thermal conductive compound under an electrical voltage above 10 KV.

The present disclosure and/or some other examples have been described in the above. According to descriptions above, various alterations/modifications may be achieved. In particular the invention is applicable to sealing and encapsulating other power magnetic components. All modifications and alterations required to be protected in the claims may be within the protection scope of the present disclosure.

It should also be noted that as the thermal conductive compound is based on a silicone resin i.e. on a “soft” type compound that seals and encapsulates the magnetic power component, this determines that this magnetic component, in addition to being encapsulated, is mechanically protected, which allows avoiding mechanical stress on, for example, in the case of a power transformer, the ferritic cores and their variation in permeability due to the magneto restriction effect.

The scope of the present invention is defined in the following set of claims.

1.-12. (canceled)

13. A thermal conductive compound for sealing a power transformer assembly, said thermal conductive compound (10) comprising
fillers, the fillers at least including:
a first filler, or main filler, the first filler being a natural mineral filler including finely divided quartz, quartzite, marble, sand and/or calcium carbonate, and
a second filler, the second filler including a given amount of aluminium hydroxide;
a silicone resin; and
wherein the fillers further include a third filler comprising a given limited amount of thermoconductive and electroconductive particles providing an electrical resistance to the thermal conductive compound (10) which ensures an electrical isolation of the thermal conductive compound (10) above 10 KV/mm.

14. The thermal conductive compound of claim 13, wherein the thermoconductive and/or electroconductive particles comprise metallic particles, metallic oxides and/or graphite.

15. A power transformer assembly (1), comprising at least a magnetic core (12A, 12B) with at least a first and a second wound coils which are sealed by a thermal conductive compound (10), the thermal conductive compound (10) comprising fillers, wherein the fillers at least include a first filler, or main filler, and a second filler, the first filler being a natural mineral filler including finely divided quartz, quartzite, marble, sand and/or calcium carbonate, and the second filler including a given amount of aluminium hydroxide;
the thermal conductive compound (10) further comprises a silicone resin; and
the fillers further include a third filler comprising a limited amount of thermoconductive and electroconductive particles providing an electrical resistance to the thermal conductive compound (10) which ensures an electrical isolation of the thermal conductive compound (10) above 10 KV/mm.

16. The power transformer of claim 15, wherein the proportion in the thermal conductive compound (10) of the first filler is between 60 and 90%.

17. The power transformer of claim 15, wherein the natural mineral filler comprises two or more different fillers of diverse granulometry.

18. The power transformer of claim 15, wherein the given amount of the aluminium hydroxide is comprised in the range of 1 and 5% by weight with regard to the total weight of the thermal conductive compound (10).

19. The power transformer of claim 15, wherein it comprises several magnetic units arranged inside a metallic box (15B) with magnetic cores (12A, 12B) and wound coils arranged inside cavities of the metallic box (15B) and delimited by metallic thermoconductive walls (16A, 16B) and a cover (15A).

20. The power transformer of claim 19, wherein the magnetic cores (12A, 12B) of the several magnetic units are arranged with a central part thereof at a same level such that an isothermal gradient of temperature under working operation of the power transformer assembly (1) is achieved.

21. The power transformer of claim 19, wherein the metallic box (15B) is made of aluminium, an aluminium alloy or a magnesium alloy with a thermal conductivity above 70 W/mK.

22. The power transformer of claim 19, wherein the metallic box (15B) comprises openings (18) in its base to allow an optimal heat transfer through the openings (18) towards a dissipation element or device located in an adjacent position.
